(19) United States
(12) Patent Application Publication
(10) Pub. No.: US 2006/0058486 A1
(43) Pub. Date: Mar. 16, 2006

(54) Alkenyl-functional organopolysiloxanes

(75) Inventor: Hans Lautenschlager, Haiming (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 11/219,900

(22) Filed: Sep. 6, 2005

(30) Foreign Application Priority Data
Sep. 16, 2004 (DE) 10 2005 044 943.0

(51) Int. Cl. C08G 77/12; C08G 77/20

(52) U.S. Cl. 528/31; 528/32

(57) ABSTRACT

Crosslinkable compositions prepared from (A) organopolysiloxanes containing alkenyl groups, of the general formula
M^{Vi}ₐ T_{b} D_{c} D^{Vi}_{d} Mₑ (I)
where M^{vi} is a unit of the formula R¹R₂SiO_{1/2},
T is a unit of the formula RSiO_{3/2},
D is a unit of the formula R₂SiO,
D^{vi} is a unit of the formula R¹RSiO, and
M is a unit of the formula R₃SiO_{1/2},
R are monovalent, SiC-bonded, optionally substituted C₁₋₁₈ hydrocarbon radicals free from aliphatic unsaturation, and
R¹ are monovalent, SiC-bonded C₂₋₈ hydrocarbon radicals having a terminal aliphatic carbon-carbon double bond, a is on average 2.5 to 8, b is on average a-2, c is on average 41 to 1000, d is on average 0 to 4, and e is on average 0 to 2,
with the proviso that a-2 M^{vi} units are attached directly to T units, (B) organosilicon compounds having Si-bonded hydrogen atoms, and (C) catalysts which promote the addition of Si-bonded hydrogen to aliphatic double bonds, have exceptional utility as abhesive coatings.

### BACKGROUND OF THE INVENTION

1. Field of the Invention

The invention relates to crosslinkable compositions comprising organopolysiloxanes containing alkenyl groups. The invention further relates to shaped bodies, especially coatings which repel tacky substances and to a process for producing such coatings. The invention relates, furthermore, to organopolysiloxanes containing alkenyl groups which are useful in preparing the crosslinkable compositions and coatings derived therefrom.

2. Background Art

In crosslinkable compositions containing organopolysiloxanes bearing alkenyl groups useful for producing coatings which repel tacky substances, particularly for release paper coatings, it is usual to use either linear diorganopolysiloxanes having terminal vinyl groups or vinylsilicone polymers of comblike construction, i.e., linear diorganopolysiloxanes which contain pendant vinyl groups attached directly to D units along the main chain. The vinyl polymers of comblike construction exhibit a lower release force than compositions containing polymers having terminal vinyl groups when self-adhesive materials such as labels are peeled at high speeds from the release paper, but exhibit a reduced crosslinking rate, which increases manufacturing time.

In U.S. Pat. No. 4,609,574, diorganopolysiloxanes having pendant higher alkenyl groups such as hexenyl groups are obtained by hydrosilylation of α,ω-dienes such as 1,5-hexadiene with diorganopolysiloxanes having pendant SiH groups. This process results in the hydrosilylation catalyst undesirably remaining in the polymer, and also to unwanted bridging of organopolysiloxane chains.

EP 640 662 B1 describes highly branched organopolysiloxanes containing unsaturated hydrocarbon groups and preferably having at least 12 T units. U.S. Pat. No. 5,616,672 describes organopolysiloxanes which contain alkenyl groups and have unspecific branching, leading to the unwanted bridging of organopolysiloxane chains. Release curves which are not very flat are obtained; in other words, the release force increases at high peel speeds. U.S. Pat. No. 4,386,135 discloses star-shaped alkenylsiloxanes which branch out from one branching site. Release curves are obtained which again are not very flat, the release force increasing at high peel speeds.

### SUMMARY OF THE INVENTION

An object of the invention was to provide crosslinkable compositions comprising organopolysiloxanes containing alkenyl groups, for which the disadvantages described above are avoided, and which exhibit relatively low release force at high peel speeds, without any decrease in crosslinking rate as a result. These and other objects are achieved by the invention, which employs alkenyl group-containing organopolysiloxanes in which at least two vinyl-substituted M units are bonded to T units.

### DETAILED DESCRIPTION OF THE PREFERRED EMBODIMENT(S)

The invention provides crosslinkable compositions comprising (A) organopolysiloxanes containing alkenyl groups, of the general formula
M^{vi}ₐ T_{b} D_{c} D^{vi}_{d} Mₑ (I)
where M^{vi} is a unit of the formula R¹R₂SiO_{1/2},
T is a unit of the formula RSiO_{3/2},
D is a unit of the formula R₂SiO,
D^{vi} is a unit of the formula R¹RSiO, and
M is a unit of the formula R₃SiO_{1/2},
R being a monovalent, SiC-bonded, unsubstituted or substituted (“optionally substituted”) hydrocarbon radical which has 1 to 18 carbon atoms and is free from aliphatic carbon-carbon double bonds and
R¹ is a monovalent, SiC-bonded hydrocarbon radical having a terminal aliphatic carbon-carbon double bond and having 2 to 8 carbon atoms per radical,
a is on average 2.5 to 8, preferably 3 to 8, more preferably 4 to 6,
b is on average a-2, preferably 1 to 6, more preferably 2 to 4,
c is on average 41 to 1000, preferably 80 to 500, more preferably 100 to 200,
d is on average 0 to 4, preferably 0 to 0.5, more preferably 0, and
e is on average 0 to 2, preferably 0 to 0.5, preferably 0, with the proviso that a-2 M^{vi} units are attached directly to T units,
(B) organosilicon compounds having Si-bonded hydrogen atoms, and
(C) catalysts which promote the addition of Si-bonded hydrogen to aliphatic double bonds.

The invention further provides organopolysiloxanes containing alkenyl groups, of the general formula
M^{vi}ₐ T_{b} D_{c} D^{vi}_{d} Mₑ (I)
where MVI is a unit of the formula R¹R₂SiO_{1/2},
T is a unit of the formula RSiO_{3/2},
D is a unit of the formula R₂SiO,
D^{vi} is a unit of the formula R¹RSiO, and
M is a unit of the formula R₃SiO_{1/2},
R being a monovalent, SiC-bonded, optionally substituted hydrocarbon radical which has 1 to 18 carbon atoms and is free from aliphatic carbon-carbon double bonds and
R¹ is a monovalent, SiC-bonded hydrocarbon radical having a terminal aliphatic carbon-carbon double bond and having 2 to 8 carbon atoms per radical,
a is on average 2.5 to 8, preferably 3 to 8, more preferably 4 to 6,
b is on average a-2, preferably 1 to 6, more preferably 2 to 4,
c is on average 41 to 1000, preferably 80 to 500, more preferably 100 to 200,
d is on average 0 to 4, preferably 0 to 0.5, more preferably 0, and
e is on average 0 to 2, preferably 0 to 0.5, preferably 0,
with the proviso that a-2 M^{vi} units are attached directly to T units.

Preference as organopolysiloxanes containing alkenyl groups (A) is given to using those of the general formula 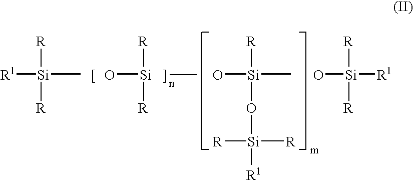
where R and R¹ are as defined above,
n is 41 to 1000, preferably 80 to 500, more preferably 100 to 200, and
m is 1 to 6, more preferably 2 to 4.

For the purposes of this invention formula (II) should be understood such that n units —(SiR₂O)— and m units —(SiRO_{3/2})(SiR₂R¹O_{1/2})— may be distributed in any way, for example blockwise or randomly, in the organopolysiloxane molecule.

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as the cyclopentyl, cyclohexyl, cycloheptyl and methylcyclohexyl radicals; aryl radicals such as the phenyl, naphthyl, anthryl and phenanthryl radicals; alkaryl radicals, such as the o-, m- and p-tolyl radicals, xylyl radicals, and ethylphenyl radicals; and aralkyl radicals such as the benzyl radical, and the α- and the β-phenylethyl radicals.

Examples of substituted radicals R are haloalkyl radicals such as the 3,3,3-trifluoro-n-propyl radical, the 2,2,2,2′,2′,2′-hexafluoroisopropyl radical, and the heptafluoroisopropyl radical, and haloaryl radicals such as the o-, m- and p-chlorophenyl radicals.

Preferably the radical R is a monovalent hydrocarbon radical having 1 to 6 carbon atoms, the methyl radical being particularly preferred. Examples of radicals R¹ are alkenyl radicals such as the vinyl, 5-hexenyl, cyclohexenyl, 1-propenyl, allyl, 3-butenyl and 4-pentenyl radicals. Preferably the radical R¹ comprises alkenyl radicals, the vinyl radical being particularly preferred.

The organopolysiloxanes (A) preferably possess an average viscosity of 100 to 10,000 mPa.s at 25° C., more preferably 200 to 1000 mPa.s at 25° C.

The organopolysiloxanes (A) of the invention may be prepared by customary methods, for example, by of H-siloxane equilibration with the corresponding silanes. Examples of organopolysiloxanes (A) of the invention are organopolysiloxanes containing vinyl groups, of the formula 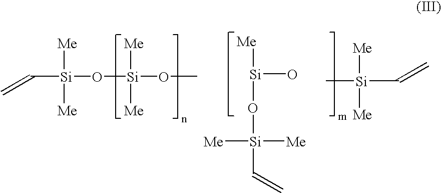
where Me is a methyl radical and n and m are as defined above.

The organopolysiloxanes (A) of the invention containing alkenyl groups are used in crosslinkable compositions and have the advantage that addition-crosslinking release systems having flat release curves, i.e., low release force behavior at high peel speeds, and also having high cure rates are obtained.

In the crosslinkable compositions organosilicon compounds (B) used which contain Si-bonded hydrogen atoms are preferably linear, cyclic or branched organopolysiloxanes comprising units of the general formula IV

$${R}_{e}^{5} {H}_{f} {SiO}_{\frac{4 - e - f}{2}} \qquad ( IV )$$

where
R⁵ is a monovalent, SiC-bonded, unsubstituted or substituted (“optionally substituted”) hydrocarbon radical having 1 to 18 carbon atoms which is free from aliphatic carbon-carbon double bonds,
e is 0, 1, 2 or 3,
f is 0, 1 or 2,
and the sum of e+f is 0, 1, 2 or 3,
   with the proviso that on average there are at least 2 Si-bonded hydrogen atoms. Examples of hydrocarbon radicals R⁵ are the same as for hydrocarbon radicals R. The organosilicon compounds (B) preferably contain at least 3 Si-bonded hydrogen atoms.

Organopolysiloxanes which are more preferredly used as organosilicon compounds (B) are those of the general formula
HₕR⁵₃₋ₕSiO(SiR⁵₂O)ₒ(SiR⁵HO)ₚSiR₅₃₋ₕHₕ (V)
where R⁵ is as defined above,
h is 0, 1 or 2,
o is 0 or an integer from 1 to 1500, and
p is 0 or an integer from 1 to 200,
   with the proviso that there are on average at least 2 Si-bonded hydrogen atoms. For the purposes of this invention formula V is to be understood such that o units —(SiR⁵₂O)— and p units —(SiR⁵HO)— may be distributed in any way in the organopolysiloxane molecule.

Examples of such organopolysiloxanes are, in particular, copolymers of dimethylhydrosiloxane, methylhydrosiloxane, dimethylsiloxane, and trimethylsiloxane units; copolymers of trimethylsiloxane, dimethylhydrosiloxane, and methylhydrosiloxane units; copolymers of trimethylsiloxane, dimethylsiloxane, and methylhydrosiloxane units; copolymers of methylhydrosiloxane and trimethylsiloxane units; copolymers of methylhydrosiloxane, diphenylsiloxane, and trimethylsiloxane units; copolymers of methylhydrosiloxane, dimethylhydrosiloxane, and diphenylsiloxane units; copolymers of methylhydrosiloxane, phenylmethylsiloxane, trimethylsiloxane and/or dimethylhydrosiloxane units; copolymers of methylhydrosiloxane, dimethylsiloxane, diphenylsiloxane, trimethylsiloxane and/or dimethylhydrosiloxane units; and copolymers of dimethylhydrosiloxane, trimethylsiloxane, phenylhydrosiloxane, dimethylsiloxane and/or phenylmethylsiloxane units.

The organopolysiloxanes (B) preferably possess an average viscosity of 10 to 1000 mPa.s at 25° C.

Organosilicon compound (B) is used preferably in amounts of 0.5 to 3.5, more preferably 1.0 to 3.0, gram atoms of Si-bonded hydrogen per mole of hydrocarbon radical R¹ having a terminal aliphatic carbon-carbon double bond in the organopolysiloxane (A).

As catalysts (C) which promote the addition of Si-bonded hydrogen to aliphatic double bonds in the crosslinkable compositions, it is possible to use any catalysts which promote the addition of Si-bonded hydrogen to aliphatic double bond. The catalysts preferably comprise a metal from the group of the platinum metals or a compound or a complex from the group of the platinum metals.

Examples of such catalysts are metallic and finely divided platinum, which may be on supports, such as silica, alumina or activated carbon, compounds or complexes of platinum, such as platinum halides, e.g., PtCl₄, H₂PtCl₆.6H₂O, Na₂PtCl₄.4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆.6H₂O and cyclohexanone, platinum-vinylsiloxane complexes, such as platinum-1,3-divinyl-1,1,3,3-tetramethyldisiloxane complexes with or without detectable inorganically bonded halogen, bis(gamma-picoline)platinum dichloride, trimethylenedipyridineplatinum dichloride, dicyclopentadieneplatinum dichloride, dimethyl sulfoxide-ethyleneplatinum(II) dichloride, cyclooctadieneplatinum dichloride, norbornadieneplatinum dichloride, gamma-picolineplatinum dichloride, cyclopentadieneplatinum dichloride, and reaction products of platinum tetrachloride with olefin and primary amine or secondary amine or primary and secondary amine, such as the reaction product of platinum tetrachloride in solution in 1-octene with sec-butylamine, or ammonium-platinum complexes.

The catalysts (C) are used preferably in amounts of 10 to 1000 ppm by weight (parts by weight per million parts by weight), more preferably 50 to 200 ppm by weight, calculated in each case as elemental platinum metal and based on the total weight of the organosilicon compounds (A) and (B).

The crosslinkable compositions may further comprise agents which retard the addition of Si-bonded hydrogen to aliphatic multiple bond at room temperature, these agents being known as inhibitors (D). As inhibitors (D) it is possible, with the crosslinkable silicone coating compositions as well, to use any inhibitor which achieves the desired purpose.

Examples of inhibitors (D) are 1,3-divinyl-1,1,3,3-tetramethyldisiloxane, benzotriazole, dialkylformamides, alkylthioureas, methyl ethyl ketoxime, organic or organosilicon compounds having a boiling point of at least 25° C. at 1012 mbar (abs.) and at least one aliphatic triple bond, such as 1-ethynylcyclohexan-1-ol, 2-methyl-3-butyn-2-ol, 3-methyl-1-pentyn-3-ol, 2,5-dimethyl-3-hexyne-2,5-diol, and 3,5-dimethyl-1-hexyn-3-ol, 3,7-dimethyloct-1-yn-6-en-3-ol, a mixture of diallyl maleate and vinyl acetate, maleic monoesters, and inhibitors such as the compound of the formula
HC≡C—C(CH₃)(OH)—CH₂—CH₂—CH ═C(CH₃)₂,
available commercially under the trade name “Dehydrolinalool” from BASF.

Where inhibitor (D) is included, it is preferably used advantageously in amounts of 0.01% to 10% by weight, more preferably 0.01 % to 3% by weight, based on the total weight of the organosilicon compounds (A) and (B).

Examples of further constituents which may be used in the crosslinkable silicone coating compositions are agents for adjusting the release force, organic solvents, adhesion promoters, and pigments. These examples are illustrative and non-limiting, and other constituents may be used if desired.

Examples of agents for adjusting the release force of the coatings which repel tacky substances and which are produced using the compositions of the invention, are silicone resins comprising units of the formula
R⁷R⁵₂SiO_{1/2} and SiO₂,
commonly known as MQ resins, where R⁷ is a hydrogen atom, a hydrocarbon radical R⁵, such as methyl radical, or an alkenyl radical R¹, such as vinyl radical, and R⁵ and R¹ are as defined above, and the units of the formula R⁷R⁵₂SiO_{1/2} may be identical or different. The ratio of units of the formula R⁷R⁵₂SiO_{1/2} to units of the formula SiO₂ is preferably 0.6 to 2. The silicone resins are used preferably in amounts of 5% to 80% by weight, based on the total weight of the organosilicon compounds (A) and (B).

Examples of organic solvents include petroleum spirits, e.g., alkane mixtures having a boiling range of 70° C. to 180° C., n-heptane, benzene, toluene and xylene(s), halogenated alkanes having 1 to 6 carbon atoms such as methylene chloride, trichloroethylene, and perchloroethylene, ethers, such as di-n-butyl ether, esters such as ethyl acetate, and ketones, such as methyl ethyl ketone and cyclohexanone. Where organic solvents are included they are preferably used in amounts of 10% to 90% by weight, more preferably 10% to 70% by weight, based on the total weight of the organosilicon compounds (A) and (B).

Although the sequence when mixing constituents (A), (B), (C), and, where appropriate, (D) is not critical, it has nevertheless been found appropriate in practice to add constituent (C), viz. the catalyst, last to the mixture of the other constituents.

The compositions of the invention are crosslinked preferably at 70° C. to 180° C. Energy sources used for crosslinking by heating are preferably ovens, examples being forced-air drying cabinets, heating tunnels, heated rollers, heated plates, or infrared thermal radiation.

Apart from by heating, the compositions of the invention can also be crosslinked by irradiation with ultraviolet light or by irradiation with UV and IR light. Ultraviolet light used is usually that having a wavelength of 253.7 nm. On the market there are a large number of lamps which emit ultraviolet light having a wavelength of 200 to 400 nm and which preferentially emit ultraviolet light having a wavelength of 253.7 nm.

The invention further provides shaped bodies produced by crosslinking the compositions of the invention. The shaped bodies preferably comprise coatings, more preferably coatings which repel tacky substances. The invention further provides a process for producing coatings by applying crosslinkable compositions of the invention to the surfaces to be coated and then crosslinking the compositions.

The crosslinkable compositions of the invention are used preferably for producing coatings which repel tacky substances, e.g., for producing release papers, i.e. “abhesive” coatings. Coatings which repel tacky substances are produced by applying crosslinkable compositions of the invention to the surfaces that are to be made repellent to tacky substances, and then crosslinking the compositions.

The application of the compositions of the invention to the surfaces to be coated, preferably surfaces to be made repellent to tacky substances, may be accomplished in any desired manner which is suitable and widely known for the production of coatings from liquid materials; for example, by dipping, brushing, pouring, spraying, rolling, printing, by means of an offset gravure coating apparatus, for example, blade or knife coating, or by means of an airbrush. The coat thickness on the surfaces to be coated is preferably from 0.3 to 6 μm, with particular preference being given to a thickness of from 0.5 to 2.0 μm.

The surfaces to be coated which may be treated in the context of the invention may be surfaces of any materials which are solid at room temperature and 1012 mbar (abs.). Examples of surfaces of this kind are those of paper, wood, cork, and polymer films, e.g., polyethylene films, polyester films or polypropylene films, woven and nonwoven fabric(s) of natural or synthetic fibers, ceramic articles, glass (including glass fibers), metals, polyethylene-coated paper, and boards, including those of asbestos. The abovementioned polyethylene may in each case be high-pressure, medium-pressure or low-pressure polyethylene. In the case of paper the paper in question may be of a low-grade kind such as absorbent papers, including kraft paper which is in the raw state, i.e., has not been pretreated with chemicals and/or natural polymeric substances, and which has a weight of from 60 to 150 g/m²; unsized papers; papers of low freeness value; mechanical papers; unglazed or uncalendered papers; papers which are smooth on one side owing to the use of a dry glazing cylinder during their production without additional complex measures, and which are therefore referred to as “machine-glazed papers”; uncoated papers; or papers produced from waste paper, i.e., what are known as recycled papers. The paper to be treated in accordance with the invention may also of course, however, comprise high-grade paper types, such as low-absorbency papers, sized papers, papers of high freeness value, chemical papers, calendered or glazed papers, glassine papers, and parchmentized papers or precoated papers. The boards may be of high or low grade. All these descriptive terms are well known to those skilled in the art.

The compositions of the invention are suitable, for example, for producing release, backing, and interleaving papers, including interleaving papers which are employed in the production of cast films or decorative films, or of foam materials, including foams of polyurethane. The compositions of the invention are also suitable, for example, for producing release, backing, and interleaving cards, films, and cloths, for treating the reverse sides of self-adhesive tapes or self-adhesive sheets themselves, or for treating the written faces of self-adhesive labels. The compositions of the invention are additionally suitable for treating packing material, such as that comprising paper, cardboard boxes, metal foils and drums, e.g., cardboard, plastic, wood or iron, which are intended for storing and/or transporting tacky goods such as adhesives, sticky foodstuffs, e.g., cakes, honey, candies, and meat; bitumen, asphalt, greased materials, and crude rubber. A further example of the application of the compositions of the invention is the treatment of carriers for transferring pressure-sensitive adhesive films in the context of what is known as the transfer process.

The compositions of the invention are suitable for producing self-adhesive materials joined to a release paper, both by the offline method and by the inline method. In the offline method, the silicone composition is applied to a substrate such as paper and crosslinked, and then, in a subsequent stage, normally after the winding of the release paper onto a roll and after the storage of the roll, an adhesive film, present for example on a label face paper, is applied to the coated paper and the composite is then compressed. In the inline method the silicone composition is applied to the paper and crosslinked, the silicone coating is coated with the adhesive, the label face paper is then applied to the adhesive, and the composite, ultimately is compressed. In the case of the offline method the winding speed is governed by the time needed to render the silicone coating tack-free. In the case of the inline method the process speed is governed by the time needed to render the silicone coating migration-free.

### EXAMPLE AND COMPARATIVE EXPERIMENTS 1 AND 2

An inventive organopolysiloxane 1 containing vinyl groups was compared in terms of its release coating suitability with known organopolysiloxanes 2 and 3 containing vinyl groups. The structure of the organopolysiloxanes 1, 2, and 3 is apparent in each case from the table. The inventive organopolysiloxane 1 was prepared from an H-siloxane equilibrate and the corresponding silane. The organopolysiloxanes 2 and 3 used in the comparative experiments were prepared by conventional equilibration of the respective components as well.

The organopolysiloxanes 1, 2, and 3 were each mixed with a linear polysiloxane comprising hydromethylsiloxane and trimethylsiloxane units in an SiH:SiVi ratio of 2:1 and the mixtures were catalyzed with 100 ppm of a platinum compound (platinum-1,3-divinyl-1,1,3,3-tetramethyldisiloxane complex). The crosslinkable compositions were applied to glassine paper on a DIXON coating unit and cured in a drying oven at 150° C. for 2.6 seconds. The degree of crosslinking was ascertained by determining the extractable silicone fraction. The release forces with respect to the acrylate adhesive A 7475 from TESA were determined at peel speeds of 0.3 m/min and 300 m/min in accordance with the standard FINAT test methods FTM 3 and FTM 4.

TABLE

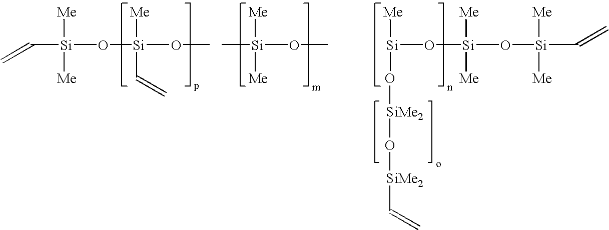

| | | | | | Extract | Release value at | Release value at |
|---|---|---|---|---|---|---|---|
| Silicone | m | n | o | p | [%] | 0.3 m/min in [N/m] | 300 m/min in [N/m] |
| 1 | 120 | 2 | 0 | 0 | 2.8 | 14.5 | 13.5 |
| (example) | | | | | | | |
| 2 | 120 | 0 | 0 | 2 | 9.4 | 29.8 | 14.1 |
| (comparative) | | | | | | | |
| 3 | 60 | 2 | 30 | 0 | 3.1 | 16.3 | 21.2 |
| (comparative) | | | | | | | |

The results show that the inventive organopolysiloxane 1 containing alkenyl groups exhibits only a slight change in release force at different peel speeds. The low extract value following a 2.6 second cure time illustrates the higher cure rate of the inventive organopolysiloxane 1 containing alkenyl groups as compared with the comparative organopolysiloxanes 2 and 3.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A crosslinkable composition comprising:
(A) organopolysiloxanes containing alkenyl groups, of the formula
M^{vi}ₐ T_{b} D_{c} D^{vi}_{d} Mₑ (I)
where M^{vi} is a unit of the formula R¹R₂SiO_{1/2},
T is a unit of the formula RSiO_{3/2},
D is a unit of the formula R₂SiO,
D^{v} is a unit of the formula R¹RSiO, and
M is a unit of the formula R₃SiO_{1/2},
R each, independently, are monovalent, SiC-bonded, optionally substituted hydrocarbon radicals having 1 to 18 carbon atoms and free from aliphatic carbon-carbon double bonds,
R¹ is a monovalent, SiC-bonded hydrocarbon radical having a terminal aliphatic carbon-carbon double bond and having 2 to 8 carbon atoms per radical,
a is on average 2.5 to 8,
b is on average a-2,
c is on average 41 to 1000,
d is on average 0 to 4, and
e is on average 0 to 2,
with the proviso that a-2 M^{vi} units on average are attached directly to T units,
(B) organosilicon compounds having Si-bonded hydrogen atoms, and
(C) catalysts which promote the addition of Si-bonded hydrogen to aliphatic double bonds.

2. The crosslinkable composition of claim 1, wherein a is from 3 to 8 and b is from 1 to 6.

3. The crosslinkable composition of claim 1, wherein at least one component (A) includes organopolysiloxanes containing alkenyl groups, of the formula 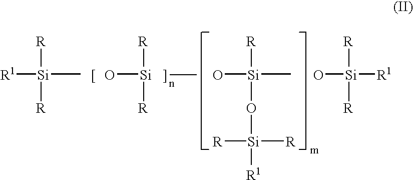
where R is a monovalent, SiC-bonded, optionally substituted hydrocarbon radical having 1 to 18 carbon atoms which is free from aliphatic carbon-carbon double bonds,
R¹ is a monovalent, SiC-bonded hydrocarbon radical having a terminal aliphatic carbon-carbon double bond and having 2 to 8 carbon atoms per radical,
n is 41 to 1000, and
m is 1 to 6.

4. The crosslinkable composition of claim 2, wherein at least one component (A) includes 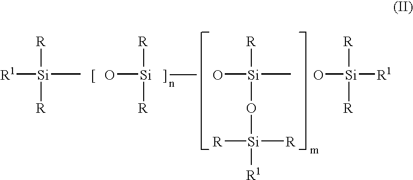
where R is a monovalent, SiC-bonded, optionally substituted hydrocarbon radical having 1 to 18 carbon atoms which is free from aliphatic carbon-carbon double bonds,
R¹ is a monovalent, SiC-bonded hydrocarbon radical having a terminal aliphatic carbon-carbon double bond and having 2 to 8 carbon atoms per radical,
n is 41 to 1000, and
m is 1 to 6.

5. The crosslinkable composition of claim 1, wherein R¹ is a vinyl radical.

6. The crosslinkable composition of claim 2, wherein R¹ is a vinyl radical.

7. The crosslinkable composition of claim 3, wherein R¹ is a vinyl radical.

8. A shaped body produced by crosslinking the composition of claim 1.

9. The shaped body of claim 8, which is a coating.

10. The shaped body of claim 8, which is a coating which repels tacky substances.

11. A process for producing a coating comprising applying a crosslinkable composition of claim 1 to a surface to be coated and then crosslinking the composition.

12. A process for producing a coating which repels tacky substances, comprising applying a crosslinkable composition of claim 1 to a surface that is to be made repellent to tacky substances, and then crosslinking the composition.

13. An organopolysiloxane containing alkenyl groups, of the general formula
M^{vi}ₐ T_{b} D_{c} D^{vi}_{d} Mₑ (I)
where M^{v} is a unit of the formula R¹R₂SiO_{1/2},
T is a unit of the formula RSiO_{3/2},
D is a unit of the formula R₂SiO,
D^{v} is a unit of the formula R¹RSiO, and
M is a unit of the formula R₃SiO_{1/2},
R each, independently, are monovalent, SiC-bonded, optionally substituted hydrocarbon radicals having 1 to 18 carbon atoms and free from aliphatic carbon-carbon double bonds,
R¹ is a monovalent, SiC-bonded hydrocarbon radical having a terminal aliphatic carbon-carbon double bond and having 2 to 8 carbon atoms per radical,
a is on average 2.5 to 8,
b is on average a-2,
c is on average 41 to 1000,
d is on average 0 to 4, and
e is on average 0 to 2,
with the proviso that a-2 M^{vi} units on average are attached directly to T units.

14. The organopolysiloxane containing alkenyl groups of claim 10, comprising an organopolysiloxane of the formula 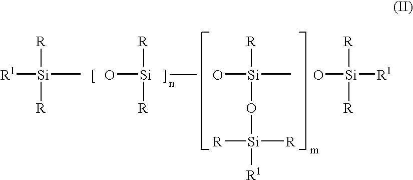
where R is a monovalent, optionally substituted hydrocarbon radical having 6 to 18 carbon atoms which is free from aliphatic carbon-carbon double bonds,
R¹ is a monovalent, SiC-bonded hydrocarbon radical having a terminal aliphatic carbon-carbon double bond and having 2 to 8 carbon atoms per radical,
n is 41 to 1000, and
m is 1 to 6.
